(19) United States
(12) Patent Application Publication
(10) Pub. No.: US 2018/0089156 A1
(43) Pub. Date: Mar. 29, 2018

(54) SYSTEMS AND METHODS FOR CONSTRUCTING PRESENTATIONS

(71) Applicant: Contiq, Inc., San Jose, CA (US)

(72) Inventors: Rahul Kapoor, San Jose, CA (US); Brahm Kiran Singh, Palo Alto, CA (US); Arun Lal, San Jose, CA (US)

(21) Appl. No.: 15/716,274

(22) Filed: Sep. 26, 2017

Related U.S. Application Data
(60) Provisional application No. 62/399,945, filed on Sep. 26, 2016.

(51) Int. Cl. G06F 17/22; G06F 17/30

(52) U.S. Cl. CPC G06F 17/2288; G06F 17/27; G06F 17/30566; G06F 17/30979

(57) ABSTRACT

In various embodiments, an automatic presentation/document builder is disclosed, where in a first phase a database/datastore is constructed from previously assembled presentations and documents including ratings/rankings for components/segments based on actions of viewers of the previously assembled presentations. In a second phase, a new presentation/document is automatically created based on interactive guidance with respect to desired goals, points, and storylines. Presentation components are automatically chosen and/or automatically suggested based on search functionality using Content Rank Scores that include weighted parameters. Newly created documents are thus assembled from segments of previously assembled presentations/documents with the new draft presentation/document based on user guidance and a stated desired outcome. In the last phase, the user is provided with machine assisted recommendation to enhance the automatically assembled presentation/document. Interactive changes to presentations/documents are used to enhance the automatic assembly of presentations/documents for subsequent users creating future presentations.

### CROSS-REFERENCE TO RELATED APPLICATION

This application claims the benefit of U.S. Provisional Patent Application No. 62/399,945 filed Sep. 26, 2016, entitled “System for Automatically Constructing Presentations and Providing Content Recommendations Based on Context and Historical Success,” by Rahul Kapoor et al., which is hereby incorporated by reference.

### BACKGROUND

When marketing or sales personnel are faced with creating a presentation to target a specific customer opportunity, each person typically relies on material they have used previously and to some extent on material they obtain from others based on specific requests. Also, creating a targeted sales presentation requires a different set of skills than those required for managing a sales process and delivering a sales pitch.

An unfortunate reality is that: (1) there may be a rich repository of presentation material available that the person building the new presentation is not aware of; and/or (2) the person building the presentation may not have the skills to create an optimum presentation for the target opportunity; and/or (3) a base presentation that the presentation creator might have ready access to may be one they are familiar with, but one that is not optimal for the target opportunity.

Especially in a large corporation with an extensive staff of sales personnel, it is very difficult to control the consistency of messaging and market positioning that a strategic marketing organization within the corporation may desire. Presentations and messaging may become diluted as sales personnel evolve presentations, sometimes in a detrimental manner if the skill set of a salesperson is not optimal for presentation creation.

### SUMMARY

Given the above, it would be useful to have a system/process that assists a presentation creator by guiding them in an interactive and automated manner towards an optimal result in creating a presentation. Such a system/process would take advantage of all presentation components available within the company, and a history of which presentation components have been successful, both in terms of use by others within the company and in terms of success with viewers at customer companies who have viewed presentations historically. It is noted that various embodiments in accordance with the present disclosure can address these issues.

In various embodiments, an automatic presentation/document builder is disclosed, where in a first phase a database/datastore is constructed from previously assembled presentations and documents including ratings/rankings for components/segments based on actions of viewers of the previously assembled presentations. In a second phase, a new presentation/document is automatically created based on interactive guidance with respect to desired goals, points, and storylines. Presentation components are automatically chosen and/or automatically suggested based on search functionality using Content Rank Scores that include weighted parameters. Newly created documents are thus assembled from segments of previously assembled presentations/documents with the new draft presentation/document based on user guidance and a stated desired outcome. In the last phase, the user is provided with machine assisted recommendation to enhance the automatically assembled presentation/document. Interactive changes to presentations/documents are used to enhance the automatic assembly of presentations/documents for subsequent users creating future presentations.

In various embodiments, a computer system can include a processor, a memory coupled to the processor, a database resident in the memory, and a user interface. The memory can include instructions for implementing a method of generating a document based on user input from the user interface. The method can include a first phase including inputting a previously assembled document and automatically operating on the document. Note that automatically operating on the document is done by analyzing the previously assembled document to determine a structure thereof and identifying specific segments, pages, or slides therein. In addition, automatically operating on the document includes identifying, classifying, and extracting assets and concepts from identified segments, pages, or slides. Furthermore, automatically operating on the document includes storing the assets and concepts in the database, with any ranking or rating related to the concepts. It is noted that the method also includes a second phase including automatically generating a version of a new document. The automatically generating includes receiving from a user, a query including one or more of: goals; messages; and a storyline, for the new document. Additionally, the automatically generating includes processing the query to identify concepts and segmentation for the query and to produce a query intent associated with the storyline for the new document. Moreover, the automatically generating includes based on the query intent, performing a search of the database to determine relevant content for the new document. In addition, the automatically generating includes processing results of the search to generate the version of the new document.

In various embodiments, the computer system can be implemented as described above within this Summary, wherein the search includes a federated search and wherein the new document is one of: a multi-slide presentation and a multi-page document.

In various embodiments, the computer system can be implemented as described above within this Summary, wherein the processing the query utilizes a query pipeline, and wherein further the query pipeline is operable to produce suggested queries for the storyline based on the previously input goals, messages, and the storyline.

In various embodiments, the computer system can be implemented as described above within this Summary, wherein the search comprises a federated search guided by a Content Rank Score (CRS) and wherein the performing a search includes matching the content with the query intent.

In various embodiments, the computer system can be implemented as described in the above paragraph, wherein the performing a search further includes re-ranking federated search results according to revisions to the CRS.

In various embodiments, the computer system can be implemented as described in the second paragraph above, wherein the federated search results are based on weighted content, assets and features.

In various embodiments, the computer system can be implemented as described in the third paragraph above, wherein the federated search results depend on ratings of document segments that were previously weighted automatically responsive to a prior viewing of a previously created document.

In various embodiments, the computer system can be implemented as described above within this Summary, further including a content creation engine and wherein the processing results of the search is performed by the content creation engine performing prioritizing CRS results according to the storyline and arranging the CRS results into storyline sections; formatting the CRS results according to formatting for the viewer; and publishing baseline content for submission to a content finishing portal.

In various embodiments, the computer system can be implemented as described in the above paragraph, wherein the method further includes processing output of the content creation engine in a content finishing portal wherein alternate segments, assets, or changes are automatically proposed to a user, and wherein segments or assets are user selectable to alter the version of the new document.

In various embodiments, the computer system can be implemented as described in the above paragraph, wherein user selections of the segments or assets are used to automatically create an updated version of the new document, and used to provide additional user choices for subsequently generated documents.

In various embodiments, in a computer system including a processor, a memory coupled to the processor, a database resident in the memory, and a user interface, a method of generating a document based on user input from the user interface, the method implemented as computer instructions stored in the memory. The method including a first phase including inputting a previously assembled document and automatically operating on the document. Note that the automatically operating on the document can include analyzing the previously assembled document to determine a structure thereof and identifying specific segments, pages, or slides therein. In addition, the automatically operating on the document can include identifying, classifying, and extracting assets and concepts from identified segments, pages, or slides. Furthermore, the automatically operating on the document can include storing the assets and concepts in the database, with any ranking or rating related to the concepts. The method can also include a second phase including automatically generating a version of a new document. The automatically generating a version of a new document can include receiving from a user, a query including one or more of: goals; messages; and a storyline, for the new document. Additionally, the automatically generating a version of a new document can include processing the query to identify concepts and segmentation for the query and to produce a query intent associated with the storyline for the new document. Moreover, the automatically generating a version of a new document can include, based on the query intent, performing a search of the database to determine relevant content for the new document. Furthermore, the automatically generating a version of a new document can include processing results of the search to generate the version of the new document.

In various embodiments, the method can be implemented as described in the above paragraph, wherein the search includes a federated search and wherein the new document is one of a multi-slide presentation and a multi-page document.

In various embodiments, the method can be implemented as described in the second paragraph above, wherein the processing the query utilizes a query pipeline, and wherein further the query pipeline is operable to produce suggested queries for the storyline based on the previously input goals, messages, and the storyline.

In various embodiments, the method can be implemented as described in the third paragraph above, wherein the search comprises a federated search guided by a CRS and wherein the performing a search includes matching the content with the query intent.

In various embodiments, the method can be implemented as described in the paragraph above, wherein the performing a search further includes re-ranking federated search results according to revisions to the CRS.

In various embodiments, the method can be implemented as described in the second paragraph above, wherein the federated search results are based on weighted content, assets and features.

In various embodiments, the method can be implemented as described in the third paragraph above, wherein the federated search results depend on ratings of document segments that were previously weighted automatically responsive to a prior viewing of a previously created document.

In various embodiments, the method can be implemented as described in the seventh paragraph above, wherein the computer system further includes a content creation engine and wherein the processing results of the search is performed by the content creation engine performing: prioritizing CRS results according to the storyline and arranging the CRS results into storyline sections; formatting the CRS results according to formatting for the viewer; and publishing baseline content for submission to a content finishing portal.

In various embodiments, the method can be implemented as described in the paragraph above, further including processing output of the content creation engine in a content finishing portal wherein alternate segments, assets, or changes are automatically proposed to a user, and wherein segments or assets are user selectable to alter the version of the new document.

In various embodiments, the method can be implemented as described in the paragraph above, wherein user selections of the segments or assets are used to automatically create an updated version of the new document, and used to provide additional user choices for subsequently generated documents.

In various embodiments, a computer readable medium can include instructions that when executed by a computer system implement a method of generating a document based on user input from a user interface. The method can include a first phase including inputting a previously assembled document and automatically operating on the document. The automatically operating on the document can include analyzing the previously assembled document to determine a structure thereof and identifying specific segments, pages, or slides therein. Furthermore, the automatically operating on the document can include identifying, classifying, and extracting assets and concepts from identified segments, pages, or slides. In addition, the automatically operating on the document can include storing the assets and concepts in a database, with any ranking or rating related to the concepts. It is noted that the method can include a second phase including automatically generating a new document. The automatically generating can include receiving from a user, a query comprising one or more of: goals; messages; and a storyline, for the new document. Further, the automatically generating can include processing the query to identify concepts and segmentation for the query and to produce a query intent associated with the storyline for the new document. Moreover, the automatically generating can include, based on the query intent, performing a search of the database to determine relevant content for the new document. Additionally, the automatically generating can include processing results of the search to generate a version of the new document.

While various embodiments in accordance with the present disclosure have been specifically described within this Summary, it is noted that the claimed subject matter are not limited in any way by these various embodiments.

### BRIEF DESCRIPTION OF THE DRAWINGS

Within the accompanying drawings, various embodiments in accordance with the present disclosure are illustrated by way of example and not by way of limitation. It is noted that like reference numerals denote similar elements throughout the drawings.

FIG. 1 shows an overview flowchart for an exemplary process including both phases of operation in accordance with various embodiments of the present disclosure.

FIG. 2 shows a process flowchart for a first phase where assets, concepts, and storylines are extracted from existing presentations/documents in accordance with various embodiments of the present disclosure.

FIG. 3 shows a data flow diagram for an exemplary process wherein during a second phase of operation a new document is constructed in accordance with various embodiments of the present disclosure.

FIG. 4 shows a flowchart for an exemplary process wherein during a second phase of operation a new document is constructed in accordance with various embodiments of the present disclosure.

FIG. 5 shows a process flowchart for the Query Understanding Pipeline described in the flowchart of FIG. 4 in accordance with various embodiments of the present disclosure.

FIG. 6 shows a content graph example in accordance with various embodiments of the present disclosure.

FIG. 7 is a block diagram of an example of a computing system upon which one or more various embodiments described herein may be implemented in accordance with various embodiments of the present disclosure.

### DETAILED DESCRIPTION

Reference will now be made in detail to various embodiments in accordance with the present disclosure, examples of which are illustrated in the accompanying drawings. While described in conjunction with various embodiments, it will be understood that these various embodiments are not intended to limit the present disclosure. On the contrary, the present disclosure is intended to cover alternatives, modifications and equivalents, which may be included within the scope of the present disclosure as construed according to the Claims. Furthermore, in the following detailed description of various embodiments in accordance with the present disclosure, numerous specific details are set forth in order to provide a thorough understanding of the present disclosure. However, it will be evident to one of ordinary skill in the art that the present disclosure may be practiced without these specific details or with equivalents thereof. In other instances, well known methods, procedures, components, and circuits have not been described in detail as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “implementing,” “inputting,” “operating,” “assembling,” “analyzing,” “determining,” “identifying,” “classifying,” “generating,” “extracting,” “receiving,” “processing,” “acquiring,” “performing,” “producing,” “providing,” “prioritizing,” “arranging,” “matching,” “formatting,” “publishing,” “ranking,” “re-ranking,” “storing,” “weighting,” “proposing,” “altering,” “creating,” “computing,” “loading” or the like, refer to actions and processes of a computing system or similar electronic computing device or processor. The computing system or similar electronic computing device manipulates and transforms data represented as physical (electronic) quantities within the computing system memories, registers or other such information storage, transmission or display devices.

Portions of the detailed description that follow are presented and discussed in terms of a method. Although steps and sequencing thereof are disclosed in figures herein describing the operations of this method, such steps and sequencing are exemplary. Any method is well suited to performing various other steps or variations of the steps recited in the flowchart of the figure herein, and in a sequence other than that depicted and described herein.

Various embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

In various embodiments, an automatic presentation/document builder is disclosed, where in a first phase a database/datastore is constructed from previously assembled presentations and documents including ratings/rankings for components/segments based on actions of viewers of the previously assembled presentations. In a second phase of operation, a new presentation/document is automatically created based on interactive guidance with respect to desired goals, points, and storylines. Presentation components are automatically chosen and/or automatically suggested based on search functionality using Content Rank Scores that include weighted parameters. Newly created documents are thus assembled from segments of previously assembled presentations/documents with the new draft presentation/document based on user guidance and a stated desired outcome. In the last phase, the user is provided with machine assisted recommendation to enhance the automatically assembled presentation/document. Interactive changes to presentations/documents are used to enhance the automatic assembly of presentations/documents for subsequent users creating future presentations.

The following is an example situation where an exemplary embodiment in accordance with the present disclosure, hereinafter call the “C-System” may be used effectively. A CompanyA enterprise sales representative (who represents a “user” of the C-System within CompanyA) wants to close a sales opportunity with a CIO (Chief Information Officer) of a large company such as for instance Telecom Target (TT). Say for example TT is looking to build a new data center that consolidates multiple old data centers into one to save 30% in Capex and 25% in Opex. CompanyA is in the running to be the software layer for TT's new data center. CompanyA is pushing its flagship product, the Software Defined Data Center (SDDC), as the key technology for this deal.

A CompanyA sales representative is aware that Competitor1 and Competitor2 are also competing for the opportunity and has already warmed the CIO of the TT with a few meetings from CompanyA's CEO and CTO. The CompanyA sales representative has to prepare and present a customer presentation to address the TT CIO's questions, and to position CompanyA (against Competitor1 and Competitor2) to win the multi-million-dollar deal.

It is noted that there is a challenge faced by the sales representative. For example, the CompanyA sales representative has uncovered many potential questions that he would need to address in the customer presentation. He has a rough idea of the flow, but is struggling with: (1) Finding the right storyline—What is the right flow/outline for the presentation and what outlines have worked well for similar audiences with similar context? (2) Targeted content for Enterprise concepts—How can the sales representative get the right information to address questions, concerns, and objections? Note that the questions and concerns raised map to the following concepts and have varying challenges: (a) Vision and Value Proposition—(i) How does the sales representative get the latest and the best content to explain this? (ii) How are the sales representative's peers pitching to their customers? (b) Competitive differentiation: a competitive program run by multiple PMMs (Product Marketing Managers) would require meetings to uncover content at the right level of detail, (c) Customer references with success metrics of actual benefits, (d) Roadmap to match RFP (Request for Proposal) needs, (e) ROI (Return on Investment) and Payback Period, (f) Customization professional services, (g) other concepts.

In the past, all the information a sales representative needs to respond with requires him to: find the right people; set up meetings; and/or exchange emails—all of which may or may not lead to the information he is looking for. As a result, this process is repeated for each RFP over and over with the following results: slow deal velocity, lost deals, waste of sales time, and lost opportunity cost due to constant reinvention of content.

Using an exemplary solution according with various embodiments of the present disclosure, the following is possible. A user (e.g., the CompanyA sales representative) uses the C-System to create a presentation. The sales representative logs on to a website such as for example “CompanyA.C-System.com”, and supplies as input to the C-System the type of presentation he needs (e.g., a customer presentation), including identifying details such as customer name, customer region, customer/presentation concerns.

Within the operation of the C-System, the “Query Understanding Pipeline” (user intent engine) and content creation engine leverage the input provided along with: concept and slide features extracted from the previously created content (e.g., slides, white papers, trip reports, and the like) created by users of the C-System within CompanyA (including the sales representative himself); Automatic Machine Training of the C-System by CompanyA's sales team, and use of the C-System within CompanyA (for example, the C-System learns which slides and features are being used more by the sales people); continual training of the C-System by: data scientists who enrich the C-System's concept learning with non-CompanyA product data; CompanyA's C-System administrator who is enriching the System's concept learning with CompanyA specific data to auto-create a baseline presentation for the sales representative (note that this presentation has both the suggested storyline and the slides for that storyline); as CompanyA's users choose the recommended content for their queries, the C-System's concept learning model is further enhanced by learning that selection. Additionally, the System presents an interactive interface that helps the sales rep further customize that baseline presentation.

To facilitate this, a machine learning algorithm incorporated into the C-System according to the various embodiments offers suggestions on: additional storylines that are appropriate to this kind of presentation and have worked well for similar customers; slides that are related to the concepts/questions that the user has articulated to the sales representative; text (e.g., bullet points, sentences) and visual elements that are appropriate to the concepts/questions needed for the presentation; and/or resources, such as people or repositories that the sales representative can leverage to refine the presentation.

As described herein, various embodiments in accordance with the present disclosure offer: sales and marketing concept extraction and learning of which content and queries best match those concepts; auto-creation of content to match those concepts; and Intelligence/Algorithms that suggest to users the best content for their needs.

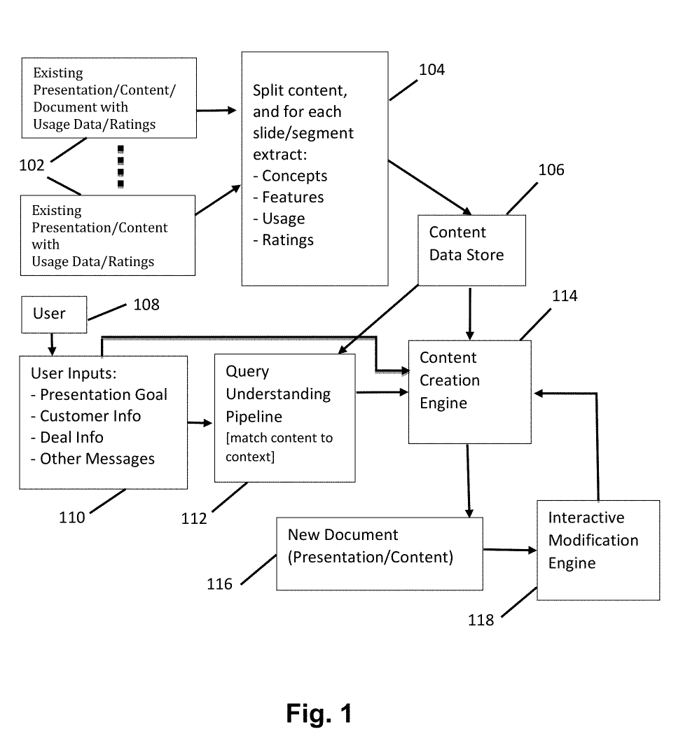

FIG. 1 shows an overview flowchart for an exemplary process including first and second phases of operation in accordance with various embodiments of the present disclosure. As part of a first phase of operation, existing presentations, content, and documents 102 are processed and key information is extracted 104 such that concepts; features; usage; and ratings related to previously presented material 102 is available for use in constructing new presentations in the future. In operation 104 a storyline is also extracted, and then the storyline along with the key information is deposited in datastore 106. During a second phase of operation, a user 108 provides inputs relative to a new presentation they wish to assemble. These user inputs 110 include a presentation goal, customer specific information, deal specific information, and other key messages. These user inputs 110 are then applied to a Query Understanding Pipeline 112 where content is matched to the context for the desired presentation in accordance with the intent of the user. The user inputs and the user intent are both applied to the content creation engine 114 which then either automatically or with some user guidance produces a new document 116 which may be a presentation, document, or other content. Subsequently an interactive modification engine 118 optimizes the presentation with user guidance in conjunction with content creation engine 114.

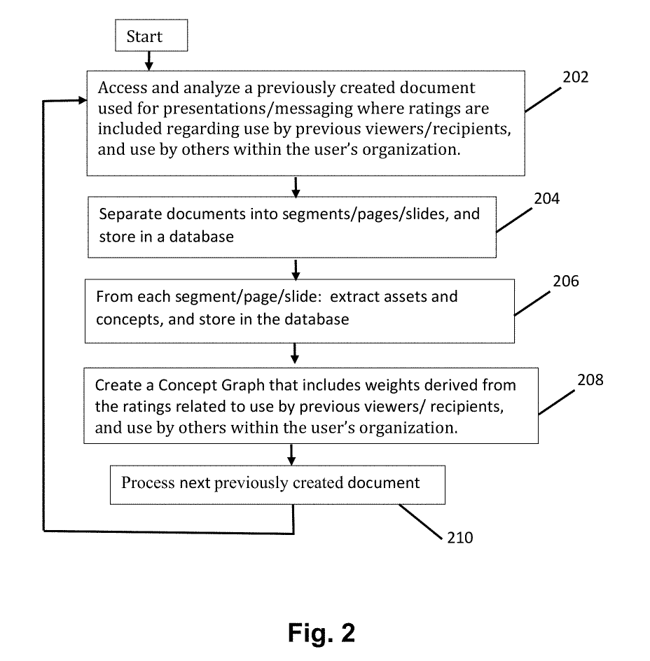

FIG. 2 shows a process flow for chart for a first phase where assets, concepts, and storylines are extracted from existing presentations/documents in accordance with various embodiments of the present disclosure. In step 202, a previously created document is accessed and analyzed, and then used for creating new presentations. Ratings are included in this process regarding use by customer recipients of previously created presentations as well as ratings related to use of presentation material within the organization to which the user belongs. In step 204, previously created presentations are separated into segments/pages/slides, and these portions are stored in a database or datastore. In step 206, assets and concepts are extracted from each segment/page/slide and stored in the database or datastore. In step 208, a concept graph is created that includes weights derived from ratings related to use by previous customer viewers/recipients and also use by other individuals within the organization to which the user belongs. Last, in step 210, a next document that was previously created is processed in a similar manner to steps 202-208.

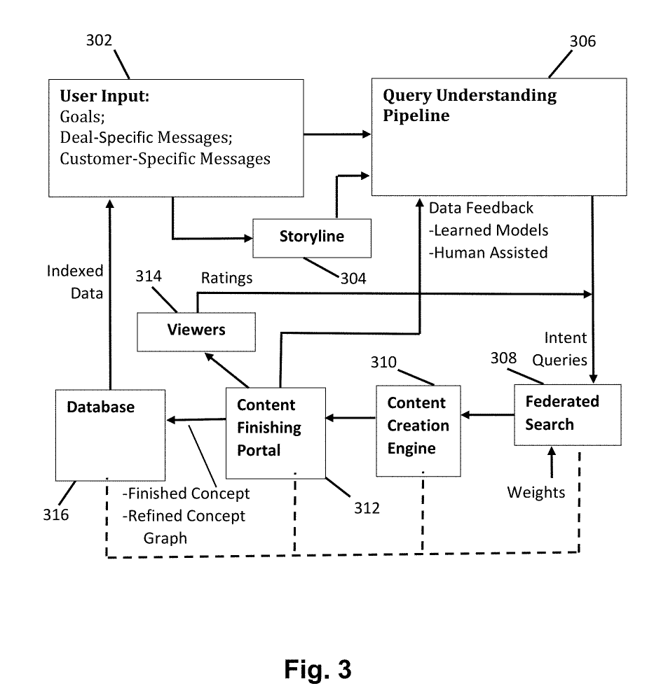

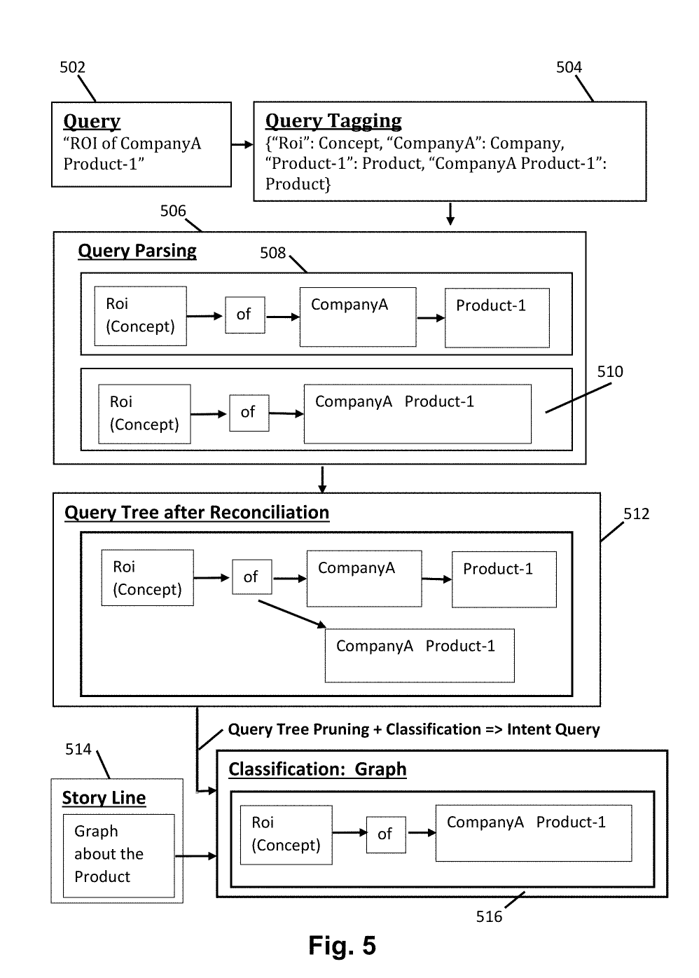

FIG. 3 shows a data flow diagram for an exemplary process wherein during a second phase of operation a new document is constructed in accordance with various embodiments of the present disclosure. In step 302, input supplied by a user of various embodiments includes goals, deal specific messages, and customer specific messages. A storyline 304 is extracted, and then the storyline 304 and user input are applied to the query understanding pipeline or user intent engine 306. Operation of the query understanding pipeline is further described in detail with reference to FIG. 5. Intent queries are produced by the query understanding pipeline 306 and these are applied to a federated search engine 308 which includes weighting. Data output by the federated search 308 is applied to content creation engine 310 which in turn feeds the content finishing portal 312. From the content finishing portal 312, a finished concept and a refined concept graph are stored in database/datastore 316. Also a finished presentation from content finishing portal 312 may be shown to viewers 314 at customer companies, and a process employed during the viewing of a presentation provides ratings relative to presentation content which are fed back into federated search 308 for use in building future presentations.

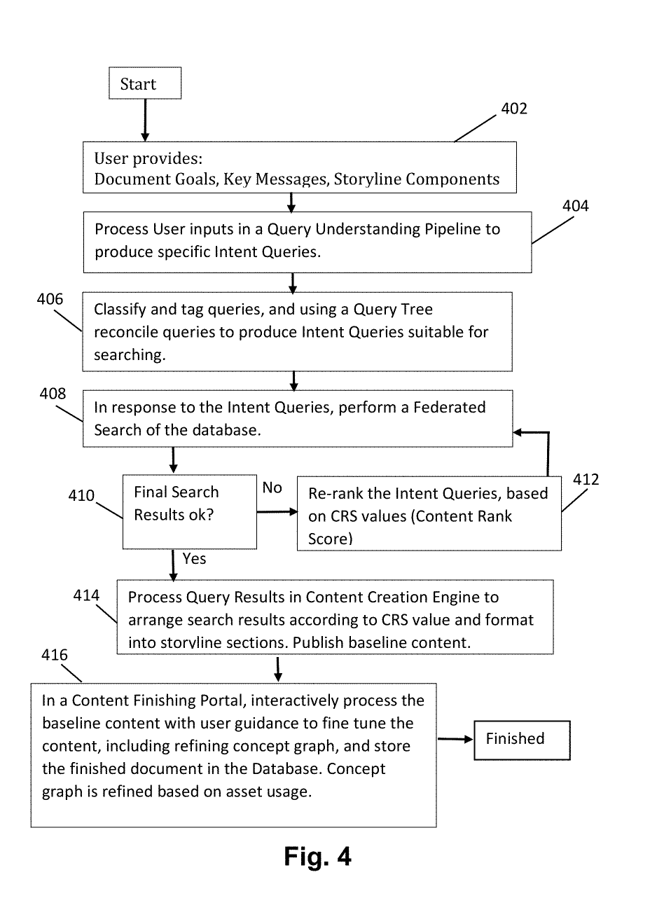

FIG. 4 shows a flowchart for an exemplary process wherein during a second phase of operation a new document is constructed in accordance with various embodiments of the present disclosure. In step 402, a user provides goals for the new presentation or document, key messages, and storyline components. In step 404, user inputs are processed in a query understanding pipeline to produce specific intent queries. In step 406, queries are classified and tagged as shown in Table 1, and using a query tree, queries are reconciled to produce intent queries suitable for searching.

TABLE 1
Asset Tag relation to Concepts

| Asset ID | Asset Description | Related Concept IDs |
|---|---|---|
| 1 | FIG. 1 from slide 2 in | 23, 24 |
| | document55 | |
| 2 | Table 1 from slide 3 in | 32, 34, 35 |
| | document11 | |
| 3 | Sentence 3 from page 118 in | 25 |
| | document23 | |
| 4 | . . . | . . . |

Query tagging identifies concepts and segmentation of queries such as (ROI, vSphere). To identify the intent of the query (since the concepts can mean several things), reconciliation is needed to form a query tree. Query classification determines what kind of information the user is looking for, for example (content, topic, people), or (“Forrestor Table on vSphere ROI”, “Services Contact for SDDC”).

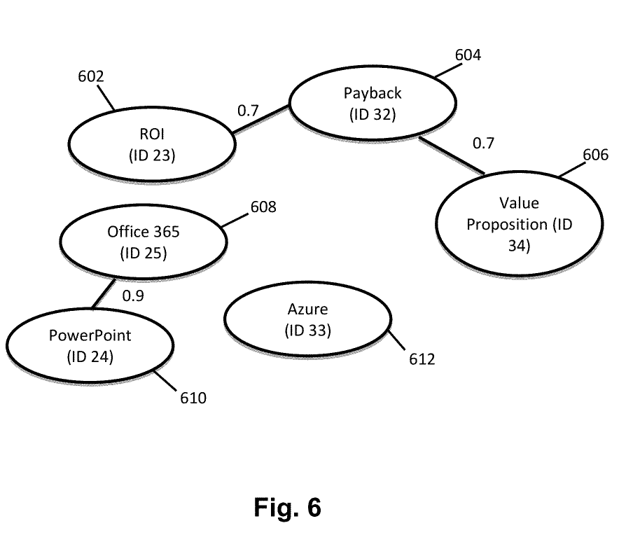

In step 408, in response to the intent queries a federated search is performed of the database to produce search results suitable for passing to a content creation engine. In step 410, a user evaluates whether the search results are acceptable. If not, intent queries are re-ranked in step 412 based on CRS values (content rank score) and the federated search 408 is performed once again. If search results 410 are acceptable, query results are processed in step 414 in the content creation engine to arrange search results according to CRS values, and format the results into storyline sections. Baseline content is also published. In step 416, the content finishing portal works with a user interactively to process the baseline content to fine-tune the content, including refining a concept graph as shown in FIG. 6, and storing the finished document in the database/datastore. The concept graph is refined based on asset usage.

Assets are ranked as shown below in Table 2:

TABLE 2
Asset Ranking Criteria

| | | Calculations |
|---|---|---|
| | | (automatic |
| Criterion | How ranking is created | or manual) |
| Relevance | Returned by Apache SOLR | Automatic |
| Usage | Process according to various | Automatic |
| | embodiments keeps track of how | |
| | many times an asset is used by | |
| | the users | |
| Visual impact | Calculated by a process | Automatic |
| | according to various | |
| | embodiments based on the | |
| | presence of features such as | |
| | image, verbosity, and white space | |
| | in the slide | |

A CRS or Content Rank Score is calculated in the “content re-ranking” module 412 where the three criteria above in Table 2 are combined together with a weighting function. Those weights may be initially set as defaults for operation in various embodiments, but can be manually modified by a C-System user (or a user company administrator for the C-System) using controls provided by the C-System.

FIG. 5 shows a process flowchart for operation of the Query Understanding Pipeline 306 as described in the flowchart of FIG. 4 in accordance with various embodiments of the present disclosure. In step 502, a user query is made. In step 504, the particular query is tagged. In step 506, the query is parsed, and two possible parsing results 508 and 510 are shown. Subsequently a query tree 512 is created according to a reconciliation. Then, as a result of query tree pruning and classification, as well as storyline 514, an intent query is applied to create a graph 516 representing the final classification for the query.

Another example of query reconciliation is demonstrated as follows: if a C-System user types “Examples of AWS Performance”, then the query can be thought of in two ways: (1) All the search results related to the three concepts: Examples, AWS, Performance; or (2) the search results related to Examples and “AWS Performance”. Query reconciliation will form these two branches and predict the most probable branch (No. 2 in this case).

FIG. 6 shows a concept graph example in accordance with various embodiments of the present disclosure that is consistent with the asset tags shown in Table 1. Concepts for ROI 602, payback 604 and value proposition 606 are shown with relationship weights connecting them. Related concepts for Office 365 608 and PowerPoint 610 are shown. Concept 612 for Azure is also shown.

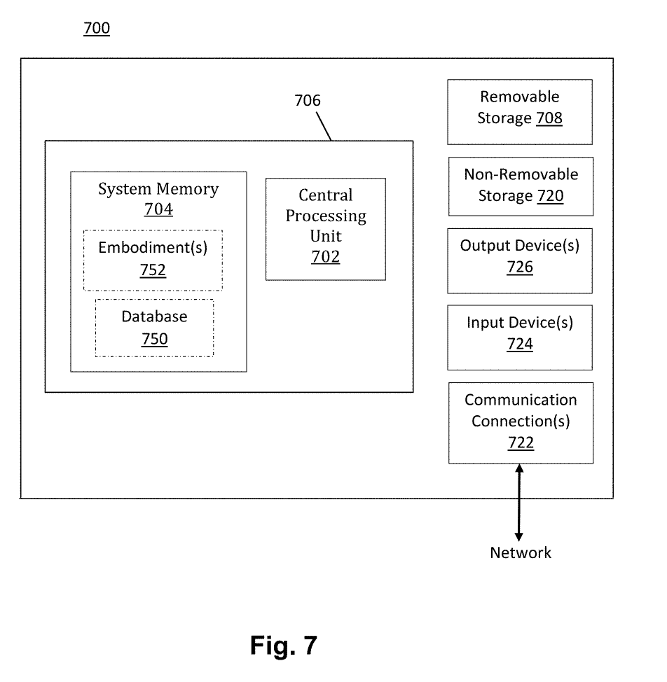

FIG. 7 shows a block diagram of an example of a computing system 700 upon which one or more various embodiments described herein may be implemented in accordance with various embodiments of the present disclosure. In a basic configuration, the system 700 includes at least one processing unit 702 and memory 704. This basic configuration is illustrated in FIG. 7 by dashed line 706. The system 700 may also have additional features and/or functionality. For example, the system 700 may also include additional storage (e.g., removable and/or non-removable) including, but not limited to, magnetic or optical disks or tape. Such additional storage is illustrated in FIG. 7 by removable storage 708 and non-removable storage 720. The system 700 may also contain communications connection(s) 722 that allow the device to communicate with other devices, e.g., in a networked environment using logical connections to one or more remote computers.

The system 700 may also includes input device(s) 724 such as a keyboard, mouse, pen, voice input device, touch input device, etc. Output device(s) 726 such as a display device, speakers, printer, etc., may also included.

In the example of FIG. 7, the memory 704 includes computer-readable instructions, data structures, program modules, and the like associated with a database 750 and one or more various embodiments 752 in accordance with the present disclosure. However, the database 750 and embodiment(s) 752 may instead reside in any one of the computer storage media used by the system 700, or may be distributed over some combination of the computer storage media, or may be distributed over some combination of networked computers, but are not limited to such.

It is noted that the computing system 700 may not include all of the elements illustrated by FIG. 7. In addition, the computing system 700 can be implemented to include one or more elements not illustrated by FIG. 7. It is pointed out that the computing system 700 can be utilized or implemented in any manner similar to that described and/or shown by the present disclosure, but is not limited to such.

The foregoing descriptions of various specific embodiments in accordance with the present disclosure have been presented for purposes of illustration and description. They are not intended to be exhaustive or to limit the present disclosure to the precise forms disclosed, and many modifications and variations are possible in light of the above teaching. The present disclosure is to be construed according to the Claims and their equivalents.

What is claimed is:

1. A computer system comprising:
a processor;
a memory coupled to said processor;
a database resident in said memory; and
a user interface, wherein said memory comprises instructions for implementing a method of generating a document based on user input from said user interface, the method comprising:
a) a first phase comprising: inputting a previously assembled document; and automatically operating on the document by:
analyzing the previously assembled document to determine a structure thereof and identifying specific segments, pages, or slides therein;
identifying, classifying, and extracting assets and concepts from identified segments, pages, or slides; and
storing the assets and concepts in the database, with any ranking or rating related to the concepts; and
b) a second phase comprising automatically generating a version of a new document, wherein the automatically generating comprises:
receiving from a user, a query comprising one or more of: goals; messages; and a storyline, for the new document;
processing the query to identify concepts and segmentation for the query and to produce a query intent associated with the storyline for the new document;
based on the query intent, performing a search of the database to determine relevant content for the new document; and
processing results of the search to generate the version of the new document.

2. The computer system as described in claim 1 wherein the search comprises a federated search and wherein the new document is one of: a multi-slide presentation; and a multi-page document.

3. The computer system as described in claim 1 wherein the processing the query utilizes a query pipeline, and wherein further the query pipeline is operable to produce suggested queries for the storyline based on the previously input goals, messages, and the storyline.

4. The computer system as described in claim 1 wherein the search comprises a federated search guided by a Content Rank Score (CRS) and wherein the performing a search comprises matching the content with the query intent.

5. The computer system as described in claim 4 wherein said performing a search further comprises re-ranking federated search results according to revisions to the CRS.

6. The computer system as described in claim 4 wherein the federated search results are based on weighted content, assets and features.

7. The computer system as described in claim 4 wherein the federated search results depend on ratings of document segments that were previously weighted automatically responsive to a prior viewing of a previously created document.

8. The computer system as described in claim 1 further comprising a content creation engine and wherein the processing results of the search is performed by the content creation engine performing:
prioritizing CRS results according to the storyline and arranging the CRS results into storyline sections;
formatting the CRS results according to formatting for the viewer; and
publishing baseline content for submission to a content finishing portal.

9. The computer system as described in claim 8 wherein said method further comprises processing output of the content creation engine in a content finishing portal wherein alternate segments, assets, or changes are automatically proposed to a user, and wherein segments or assets are user selectable to alter the version of the new document.

10. The computer system as described in claim 9 wherein user selections of said segments or assets are used to automatically create an updated version of the new document, and used to provide additional user choices for subsequently generated documents.

11. In a computer system comprising: a processor; a memory coupled to said processor; a database resident in said memory; and a user interface, a method of generating a document based on user input from said user interface, the method implemented as computer instructions stored in said memory and wherein said method comprising:
a) a first phase comprising: inputting a previously assembled document; and automatically operating on the document by:
analyzing the previously assembled document to determine a structure thereof and identifying specific segments, pages, or slides therein;
identifying, classifying, and extracting assets and concepts from identified segments, pages, or slides; and
storing the assets and concepts in the database, with any ranking or rating related to the concepts, and
b) a second phase comprising automatically generating a version of a new document by:
receiving from a user, a query comprising one or more of: goals; messages; and a storyline, for the new document;
processing the query to identify concepts and segmentation for the query and to produce a query intent associated with the storyline for the new document;
based on the query intent, performing a search of the database to determine relevant content for the new document; and
processing results of the search to generate the version of the new document.

12. The method as described in claim 11 wherein the search comprises a federated search and wherein the new document is one of: a multi-slide presentation; and a multi-page document.

13. The method as described in claim 11 wherein the processing the query utilizes a query pipeline, and wherein further the query pipeline is operable to produce suggested queries for the storyline based on the previously input goals, messages, and the storyline.

14. The method as described in claim 11 wherein the search comprises a federated search guided by a Content Rank Score (CRS) and wherein the performing a search comprises matching the content with the query intent.

15. The method as described in claim 14 wherein said performing a search further comprises re-ranking federated search results according to revisions to the CRS.

16. The method as described in claim 14 wherein the federated search results are based on weighted content, assets and features.

17. The method as described in claim 14 wherein the federated search results depend on ratings of document segments that were previously weighted automatically responsive to a prior viewing of a previously created document.

18. The method as described in claim 11 wherein said computer system further comprises a content creation engine and wherein the processing results of the search is performed by the content creation engine performing:
prioritizing CRS results according to the storyline and arranging the CRS results into storyline sections;
formatting the CRS results according to formatting for the viewer; and
publishing baseline content for submission to a content finishing portal.

19. The method as described in claim 18 further comprising processing output of the content creation engine in a content finishing portal wherein alternate segments, assets, or changes are automatically proposed to a user, and wherein segments or assets are user selectable to alter the version of the new document.

20. The method as described in claim 19 wherein user selections of said segments or assets are used to automatically create an updated version of the new document, and used to provide additional user choices for subsequently generated documents.

21. A computer readable medium comprising instructions that when executed by a computer system implement a method of generating a document based on user input from a user interface, the method comprising:
a) a first phase comprising: inputting a previously assembled document; and automatically operating on the document by:
analyzing the previously assembled document to determine a structure thereof and identifying specific segments, pages, or slides therein;
identifying, classifying, and extracting assets and concepts from identified segments, pages, or slides; and
storing the assets and concepts in a database, with any ranking or rating related to the concepts, and
b) a second phase comprising automatically generating a new document, said automatically generating comprising:
receiving from a user, a query comprising one or more of: goals; messages; and a storyline, for the new document;
processing the query to identify concepts and segmentation for the query and to produce a query intent associated with the storyline for the new document;
based on the query intent, performing a search of the database to determine relevant content for the new document; and
processing results of the search to generate a version of the new document.
